(19) United States
(12) Patent Application Publication
(10) Pub. No.: US 2025/0230045 A1
(43) Pub. Date: Jul. 17, 2025

(54) METHOD FOR PRODUCING ALKALI SULFONYL IMIDE SALTS

(71) Applicant: SPECIALTY OPERATIONS FRANCE, Lyon (FR)

(72) Inventors: Etienne Schmitt, Soucieu-En-Jarrest (FR); Elie Derrien, Brignais (FR)

(73) Assignee: SPECIALTY OPERATIONS FRANCE, Lyon (FR)

(21) Appl. No.: 18/844,881

(22) PCT Filed: Feb. 24, 2023
(86) PCT No.: PCT/EP2023/054723

§ 371 Date: Sep. 6, 2024

(30) Foreign Application Priority Data
Mar. 7, 2022 (EP) 22305259.8

(51) Int. Cl. C01B 21/093

(52) U.S. Cl. CPC C01B 21/0935; C01P 2006/80

(57) ABSTRACT

The present invention relates to a method for producing a salt of bis(chlorosulfonyl) imide, which is economically feasible at industrial scale and which provides a high-purity product.

### REFERENCE TO RELATED APPLICATION

This application claims priority to earlier European Patent Application filed on 7 Mar. 2022 with Nr 22305259.8, the whole content of this application being incorporated herein by reference for all purposes.

### TECHNICAL FIELD

The present invention relates to a method for producing a salt of bis(chlorosulfonyl)imide, which is economically feasible at industrial scale and which provides a high-purity product.

### BACKGROUND

Fluorosulfonylimide salts, in particular the lithium salt of bis(fluorosulfonyl)imide (LiFSI), are useful compounds for battery electrolytes. Different processes, reactants and intermediates leading to LiFSI have been described in the patent literature, notably patent CA 2 527 802 (Université de Montréal) which lists several routes to prepare LiFSI, for example the process for preparing LiFSI in one step starting from bis(chlorosulfonyl)imide (HCSI) using anhydrous hydrogen fluoride (HF):

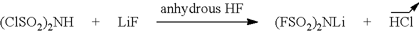

One of the alternate known processes to prepare LiFSI is a two-step process and involves the fluorination of bis(chlorosulfonyl)imide (HCSI) into bis(fluorosulfonyl)imide (HFSI) using a fluorination agent, for example anhydrous hydrogen fluoride (HF), and then the lithiation of HFSI into LiFSI using a lithiation agent.

Another known two-step process for preparing LiFSI involves a first step of fluorination of bis(chlorosulfonyl)imide (HCSI) into ammonium bis(fluorosulfonyl)imide (NH₄FSI) using NH₄F(HF)ₓ as a fluorinating agent, followed by a second step of lithiation of NH₄FSI, leading then to the LiFSI product. Such a process is described for example in WO 2017/090877 A1 (CLS) and EP 3 170 789 A1 (Nippon Soda).

Another known two-step process for preparing LiFSI involves the lithiation of HCSI in a first step using a lithiation agent in order to prepare LiCSI as an intermediate product, and then the fluorination of LiCSI into LiFSI using a fluorination agent. For example, KR 20200049164 (CLS) relates to a LIFSI preparation method, comprising a step reacting HCSI with various lithiation reagents in an (S1) solvent to produce LiCSI and then reacting it with an anhydrous fluorination reagent directly without purification. A long list of possible solvents is given in the specification, while dimethyl carbonate is used in the examples.

As can be read from the patent literature above-cited, the production of bis(fluorosulfonyl)imide, salts thereof and intermediate products, takes place in solvents, for example organic solvents, in order to disperse the reactive entities and allow them to react.

### SUMMARY OF THE INVENTION

The Applicant perceived that there is still the need in the art for improving the manufacturing process of the intermediate compounds that are used in the manufacture of bis(chlorosulfonyl)imide salts.

In particular, the Applicant is well aware that in the processes disclosed in the prior art usually the solvent(s) might have to be treated to remove the residual amount of water and/or need to be removed after the reaction. This step for removing the solvent adds to the complexity of the industrial process, as well as its overall cost.

With the aim of overcoming the above drawbacks, the Applicant faced the problem of providing a simpler production process for preparing bis(chlorosulfonyl)imide salts, which notably does not require the use of a solvent.

Thus, in a first aspect, the present application relates to a method for producing a salt of bis(chlorosulfonyl)imide comprising the steps of:
(a) providing bis(chlorosulfonyl)imide (HCSI);
(b) melting said HCSI provided in step (a) to obtain a molten HCSI; and
(c) contacting said molten HCSI obtained in step (b) with a compound of formula (I):

M⁺B⁻ (I)
wherein
M is selected from Na, Li, K, Ce, Rb and Fr and
B is selected from Cl; F; carbonate (CO₃²⁻); sulphate (SO₄²⁻); carboxylate; silicate, preferably metasilicate; borate, preferably tetraborate; and mixtures thereof; and allow the reaction to proceed, to produce the salt of bis(chlorosulfonyl)imide,
wherein the method, notably steps (b) to (d), is carried out in the absence of solvent.

The salt of bis(chlorosulfonyl)imide obtained with the method of the present invention is characterised by a non-detectable amount of solvent, which makes it well-suited for many applications, notably as an intermediate to prepare LiFSI used in battery applications.

Advantageously, the method of the present invention is carried out in molten HCSI, which acts to disperse the compound of formula (I), in the absence of solvents and diluents. In other words, the method of the present invention is a solvent-free method, which means that no solvent and/or diluent is added to the reaction mixture during the reaction. This is advantageous because first, the step for removing the solvent is avoided, thus reducing the complexity of the industrial process, as well as its overall cost and secondly, the preliminary step of treating the solvent to decrease its moisture content is also avoided.

### DETAILED DESCRIPTION

In the present application:
the expression “between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents;
the term “solvent” is intended to mean a compound which presents the following three cumulative properties of 1/being present from the beginning to the end of the reaction, possibly added during the process, 2/unchanged during the process, in other words non-reactive towards the involved reactants, and 3/having to be removed at the end of the process in case the reaction product is to be in its pure form. For sake of clarity, the molten HCSI used in the process of the present invention does not fall in the definition of and is not intended as “solvent” or “diluent” as above-mentioned. Solvents which are typically used in such processes are well-known and extensively described in the literature. Such solvents may be aprotic, for example polar aprotic solvents, and may selected from the group consisting of:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide, and
cyano-, nitro-, chloro- or alkyl-substituted alkane or aromatic hydrocarbon, for instance acetonitrile, valeronitrile, adiponitrile, benzonitrile, nitromethane, nitrobenzene.

In the context of the present invention, the starting HCSI as provided in step (a) may be produced by a known method, for example:
by reacting chlorosulfonyl isocyanate (ClSO₂NCO) with chlorosulfonic acid (ClSO₂OH);
by reacting cyanogen chloride (CNCl) with sulfuric anhydride (SO₃), and with chlorosulfonic acid (ClSO₂OH); or
by reacting sulfamic acid (NH₂SO₂OH) with thionyl chloride (SOCl₂) and with chlorosulfonic acid (ClSO₂OH).

In one embodiment, the starting HCSI is produced by reacting chlorosulfuric acid (ClSO₂OH) and chlorosulfonyl isocyanate (ClSO₂NCO). According to this embodiment, step (i) consists in preparing a reaction mixture comprising HCSI, heavy fractions and light fractions in a reactor, by reacting chlorosulfonyl isocyanate (ClSO₂NCO) with chlorosulfonic acid (ClSO₂OH).

In another embodiment, the starting HCSI is produced by reacting sulfamic acid (NH₂SO₂OH), chlorosulfonic acid (ClSO₂OH) and thionyl chloride (SOCl₂). The sulfamic acid to be applied may be ground to a certain particle size and dried under vacuum to decrease its water content and accelerate the kinetics of the transformation, which significantly reduces the reaction time.

In the other embodiment, the starting HCSI is produced by reacting cyanogen chloride CNCl with sulfuric anhydride (SO₃) and chlorosulfonic acid (ClSO₂OH).

According to the method of the present invention, in step (b) HCSI is heated above its melting temperature (Tm_{HCSI}), before the addition of the compound of formula (I), in order to be in a molten state (also called liquid state).

Preferably, step (b) is performed at a temperature (Tb) suitable for melting HCSI and maintaining HCSI in the molten state, while its degradation is avoided.

Step (b) is conducted at a temperature (Tb) equal to or above the melting point (Tm) of HCSI (Tm_{HCSI}). In this case, Tb≥Tm_{HCSI}. For example, Tb may be equal to or above the melting point Tm of HCSI (Tm_{HCSI}) plus 5° C. In this case, Tb≥Tm_{HCSI}+5. As another example, Tb may be equal to or above the melting point Tm of HCSI (Tm_{HCSI}) plus 10° C. In this case, Tb≥Tm_{HCSI}+10.

The person skilled in the art will understand that the Tm of HCSI is influenced by the presence and amounts of impurities.

Preferably, the temperature (Tb) at which step (b) is conducted is equal to or higher than 30° C., for example equal to or higher than 37° C., for example equal to or higher than 38° C., equal to or higher than 40° C., equal to or higher than 45° C. or even equal to or higher than 50° C. In any case, the temperature (Tb) at which step (b) is conducted is below the degradation temperature of HCSI.

Preferably, under step (c), said compound of formula (I) is added into the reaction mixture, either progressively or at once.

Alternatively, molten (HCSI) is added, either progressively or at once, to said compound of formula (I) previously loaded in a reactor.

The person skilled in the art will understand that other ingredients or reactants, either in a powder form or in a liquid form, can be added to the reaction environment based on the needs or circumstances.

In some embodiments, the molar ratio HCSI to the compound of formula (I) ranges from 0.001:1 to 20:1, in particular from 0.1:1 to 10:1, more particularly from 0.5:1 to 5:1, even more particularly being about 1:1.

Preferably, in said compound of formula (I), M is selected from Na, Li and K.

Even more preferably, M is Li. According to this embodiment, the compound of formula (I) will be referred to as “compound LiX”.

According to this embodiment, the compound LiX to be used in the method of the invention is a component, which does not generate water or soluble species over the course of the reaction.

In some preferred embodiments, said compound LiX is selected from the group consisting of lithium chloride (LiCl), lithium fluoride (LiF), lithium carbonate (Li₂CO₃), lithium sulphate (Li₂SO₄), lithium carboxylate (Liₙ(RCO₂)ₙ), Li₂SiO₃, Li₂B₄O₇ and mixtures thereof.

Even more preferably, said compound LiX is anhydrous lithium chloride (LiCl) in a solid form.

Depending on the circumstances, said step (b) and step (c) can be conducted at the same temperature or at different temperatures.

The person skilled in the art will understand that the choice of the compound of formula (I) influences the temperature at which step (c) is performed. Detailed description of step (c) as provided hereinafter refers to the step in which in compound (I), M is Li and hence the salt as obtained at the end of step (C) is lithium bis(chlorosulfonyl)imide (LiCSI).

Preferably, when step (c) is conducted at a temperature (Tc) at which LiCSI is in a liquid form, which is a temperature equal or above the melting point (Tm) of LiCSI (Tm_{LiCSI}). In this case, Tc≥Tm_{LiCSI}. For example, Tc may be equal to or above the melting point Tm of LiCSI (Tm_{LiCSI}) plus 5° C. In this case, Tc≥Tm_{LiCSI}+5. As another example, Tc may be equal to or above the melting point Tm of LiCSI (Tm_{LiCSI}) plus 10° C. In this case, Tc≥Tm_{LiCSI}+10.

Alternatively and more preferably, step (c) is conducted at a temperature (Tc) such that HCSI is in a molten state, i.e. Tc≥Tm_{HCSI}, and LiCSI is, at least partially, in solid form, i.e. Tc≤Tm_{LiCSI}. According to this embodiment, Tc may be equal to or below the melting point Tm of LiCSI (Tm_{LiCSI}) minus 5° C. In this case, Tc≤Tm_{LiCSI}−5. As another example, Tc may be equal or below the melting point Tm of LiCSI (Tm_{LiCSI}) minus 10° C. In this case, Tc≤Tm_{LiCSI}−10. In other words, according to these embodiments, the temperature Tc at which step (c) is conducted varies between the melting point of HCSI (Tm_{HCSI}) and the melting point of LiCSI (Tm_{LiCSI}).

Preferably, the temperature (Tc) at which step (c) is conducted is equal to or higher than 37° C., for example equal to or higher than 50° C., equal to or higher than 60° C., equal to or higher than 80° C. or even equal to or higher than 100° C. In some embodiments, the temperature (Tc) at which step (c) is conducted is equal to or less than 220° C., for example equal to or less than 218° C., equal to or less than 215° C., equal to or less than 212° C. or even equal to or higher than 210° C.

Each of step (b) and/or step (c) can be conducted at atmospheric pressure or under reduced pressure. For example, each of step (b) and step (c) may be conducted under vacuum or at a pressure around 1 atm, preferably 1 atm.

In embodiments in which the temperature (Tc) at which step (c) is conducted varies between the melting point of HCSI (Tm₁) and the melting point of LiCSI (Tm₂), the molar ratio HCSI to compound LiX is preferably such that HCSI is the excess reactant, so that non converted HCSI make the final reaction medium processable for further LiCSI filtration. For example, the molar ratio HCSI to compound LiX is 2:1.

In other embodiments in which temperature (Tc) at which step (c) is conducted is higher or equal to the melting point of LiCSI (Tm₂), the molar ratio HCSI to compound LiX is preferably such that compound LiX is the excess reactant, so that HCSI can be fully converted and compound LiX filtrated to provide isolated LiCSI. For example, the molar ratio HCSI to compound LiX is 1:1.05.

Preferably, when LiCl is used, the hydrogen chloride (HCl) formed as a by-product during step (b) and/or step (c) is continuously removed from the reaction vessel during step (b) and/or step (c). For example, HCl removal is performed under vacuum or by stripping using an inert gas (such as nitrogen, helium or argon) flow in the reaction vessel sky or inside the liquid reaction mixture. The sparged HCl can be further recycled.

Preferably, the method according to the present invention comprises, after step (c), a step (d) comprising the separation of the salt of bis(chlorosulfonyl)amide from the reaction mixture. When the method comprises step (d), the HCSI remaining after the reaction can be reused. The remaining HCSI is preferably in the molten state.

This separation step can be performed by any separation means known by the person skilled in the art. Separation may be performed for example by filtration, for instance under pressure or under vacuum, or decantation. Mesh size of the filtration medium may be for example 2 μm or below, of 0.45 μm or below, or of 0.22 μm or below. The separated product(s) may be washed once or several times with appropriate solvent. The separation step may be carried out one time or may be repeated twice or more if necessary.

Some of the steps or all steps of the method according to the invention are advantageously carried out in equipment capable of withstanding the corrosion of the reaction medium.

For this purpose, materials are selected for the part in contact with the reaction medium that are corrosion-resistant, such as the alloys based on molybdenum, chromium, cobalt, iron, copper, manganese, titanium, zirconium, aluminium, carbon and tungsten, sold under the Hastelloy® brands or the alloys of nickel, chromium, iron and manganese to which copper and/or molybdenum are added, sold under the name Inconel® or Monel™, and more particularly the Hastelloy C276 or Inconel 600, 625 or 718 alloys. Stainless steels may also be selected, such as austenitic steels and more particularly the 304, 304L, 316 or 316L stainless steels. A steel having a nickel content of at most 22 wt. %, preferably of between 6 wt. % and 20 wt. % and more preferentially of between 8 wt. % and 14 wt. %, is used. The 304 and 304L steels have a nickel content that varies between 8 wt. % and 12 wt. %, and the 316 and 316L steels have a nickel content that varies between 10 wt. % and 14 wt. %. More particularly, 316L steels are chosen. Use may also be made of equipment consisting of or coated with a polymeric compound resistant to the corrosion of the reaction medium. Mention may in particular be made of materials such as PTFE (polytetrafluoroethylene or Teflon) or PFA (perfluoroalkyl resins). Glass and glass-lined as well as enamel equipment may also be used. It will not be outside the scope of the invention to use an equivalent material. Materials for filtration have to be compatible with the medium used. Fluorinated polymers (PTFE, PFA), loaded fluorinated polymers (Viton™), as well as polyesters (PET), polyurethanes, polypropylene, polyethylene, cotton, and other compatible materials can be used.

All raw materials used in the method according to the invention, including reactants, may preferably show very high purity criteria. Preferably, their content of metal components such as Na, K, Ca, Mg, Fe, Cu, Cr, Ni, Zn, is below 10 ppm, more preferably below 5 ppm, or below 2 ppm.

The bis(chlorosulfonyl)imide salt as obtained at the end of the process of the present invention can be advantageously used as such for other reactions.

According to a preferred embodiment, when compound (I) comprises M as Li, the lithium salt obtained by the process of the present invention can be used for the preparation of LiFSI.

Alternatively, LiCSI salt as obtained at the end of the process of the present invention may be contacted with one or more organic solvent(s), to obtain a crystallised LiCSI.

In a second aspect, the present invention relates to a salt of bis(chlorosulfonyl)imide obtainable by the method described above, characterised in that its organic solvent content is less than 100 ppm.

In some preferred embodiments, the amount of solvent in the bis(chlorosulfonyl)imide salt is less than 100 ppm, for example less than 90 ppm, less than 80 ppm, less than 70 ppm, less than 60 ppm, less than 50 ppm, less than 40 ppm, less than 30 ppm, less than 20 ppm, less than 10 ppm, or even less than 1. This is an advantageous feature of the salt obtained by the process of the present invention. The remaining solvent content may be determined by gas chromatography (GC) or by headspace sad chromatography.

The bis(chlorosulfonyl)imide salt as obtained at the end of the method of the present invention is in a molten state or in a crystallised form.

In a third aspect, the present invention relates to the use of a lithium salt of bis(chlorosulfonyl)imide obtainable by the method described above, for the manufacture of lithium bis(fluorosulfonyl)imide (LiFSI).

In a further aspect, the present invention relates to a method for manufacturing a salt of bis(fluorosulfonyl)imide comprising the steps (a), (b), (c) and optionally (d), as disclosed above
and after said step (c) or said step (d), step (e) of contacting said salt of bis(chlorosulfonyl)amide as obtained in step (c) or in step (d) with at least one fluorinating agent,
wherein steps (a) to (d) are carried out in the absence of solvent.

Preferably, said at least one fluorinating agent if selected from anhydrous HF, or from the group comprising the following formulae:

KF(HF)ₚ wherein p is 0 or 1; (i)

NaF(HF)ₚ wherein p is 0 or 1; (ii)

X₂F(HF)ₚ wherein X₂ is an onium cation, and p is 0 or 1; (iii)

NH₄F(HF)ₚ wherein p varies between 0 and 10; (iv)

LiF; (v)

ZnF₂ (vi)

Should the disclosure of any patents, patent applications, and publications which are incorporated herein by reference conflict with the description of the present application to the extent that it may render a term unclear, the present description shall take precedence.

1. A method for manufacturing a salt of bis(chlorosulfonyl)imide comprising the step of:
(a) providing bis(chlorosulfonyl)imide (HCSI);
(b) melting said bis(chlorosulfonyl)imide (HCSI) provided in step (a) to obtain a molten bis(chlorosulfonyl)imide (HCSI); and
(c) contacting said molten bis(chlorosulfonyl)imide (HCSI) obtained in step (b) with a compound of formula (I):
M⁺B⁻ (I)
wherein
M is selected from Na, Li, K, Ce, Rb and Fr and B is selected from Cl; F; carbonate (CO₃²⁻); sulphate (SO₄²⁻); carboxylate; silicate, borate, and mixtures thereof; and
allow the reaction to proceed, to produce the salt of bis(chlorosulfonyl)imide,
wherein the method is carried out in the absence of solvent.

2. The method according to claim 1, wherein step (c) comprises:
adding said compound of formula (I) to said molten HCSI, either progressively or at once; or
loading said compound of formula (I) into a reactor and adding said molten HCSI, either progressively or at once.

3. The method according to claim 1, wherein the molar ratio HCSI to the compound of formula (I) ranges from 0.001:1 to 20:1.

4. The method according to claim 1, wherein in said compound of formula (I), M is selected from Na, Li and K and/or B is selected from Cl, F, carbonate and sulphate.

5. The method according to claim 1, wherein:
step (b) is conducted at a temperature equal to or higher than 30° C.; and/or
step (b) and step (c) are performed at the same temperature or at a different temperature; and/or
each of step (b) and step (c) is performed at atmospheric pressure or under reduced pressure; and/or
step (c) is performed at a temperature equal to or higher than 37° C. and equal to or less than 220° C.; and/or
the molar ratio of the HCSI to the compound of formula (I) ranges from 0.001:1 to 20:1.

6. The method according to claim 1, wherein in said compound of formula (I) M is Li [compound LiX], said salt of bis(chlorosulfonyl)imide is LiCSI and:
step (c) is performed at a temperature between the melting point of HCSI (Tm₁) and the melting point of LiCSI (Tm₂) and the molar ratio HCSI to the compound of formula (I) is such that HCSI is the excess reactant; or
step (c) is performed at a temperature higher than or equal to the melting point of LiCSI (Tm2), the molar ratio HCSI to the compound of formula (I) is such that compound LiX is the excess reactant.

7. The method according to claim 1, wherein said compound of formula (I) is selected from the group consisting of lithium chloride (LiCl), lithium fluoride (LiF), lithium carbonate (Li₂CO₃), lithium sulfate (Li₂SO₄), lithium carboxylate (Liₙ(RCO₂)ₙ), Li₂SiO₃, Li₂B₄O₇ and mixtures thereof.

8. The method according to claim 7, wherein said compound of formula (I) is LiCl.

9. The method according to claim 8, wherein the hydrogen chloride (HCl) formed as a by-product during step (b) and/or step (c) is continuously removed from the reaction vessel during step (b) and/or step (c).

10. The method according to claim 9, wherein HCl removal is performed by stripping using an inert gas flow in the reaction vessel sky or inside the liquid reaction mixture.

11. The method according to claim 1, said method comprising after step (c), a step (d) comprising the separation of the salt of bis(chlorosulfonyl)amide from the reaction mixture.

12. A salt of bis(chlorosulfonyl)imide obtained by the method according to claim 1, characterised in that its organic solvent content is less than 100 ppm, as determined by gas chromatography.

13. The salt of bis(chlorosulfonyl)imide according to claim 12, which is the lithium salt of bis(chlorosulfonyl)imide.

14. A method of manufacturing lithium bis(fluorosulfonyl)imide (LiFSI), the method comprising preparing LiFSI from an intermediate compound, wherein the intermediate compound is a salt of the lithium salt of bis(chlorosulfonyl)imide according to claim 13.

15. A method for manufacturing a salt of bis(fluorosulfonyl)imide comprising the step of:
(a) providing bis(chlorosulfonyl)imide (HCSI);
(b) melting said bis(chlorosulfonyl)imide (HCSI) provided in step (a) to obtain a molten bis(chlorosulfonyl)imide (HCSI); and
(c) contacting said molten bis(chlorosulfonyl)imide (HCSI) obtained in step (b) with a compound of formula (I):
M⁺B⁻ (I)
wherein
M is selected from Na, Li, K, Ce, Rb and Fr and
B is selected from Cl; F; carbonate (CO₃²⁻); sulphate (SO₄²⁻); carboxylate; silicate; borate; and mixtures thereof;
and allow the reaction to proceed, to produce the salt of bis(chlorosulfonyl)imide;
(d) optionally, separating the salt of bis(chlorosulfonyl)amide from the reaction mixture, and
(e) contacting said salt of bis(chlorosulfonyl)amide as obtained in step (c) or in step (d) with at least one fluorinating agent,
wherein steps (a) to (d) are carried out in the absence of solvent.

16. The method according to claim 8, wherein the compound of formula (I) is anhydrous LiCl and in a solid form.
